(19) United States
(12) Patent Application Publication
(10) Pub. No.: US 2010/0134466 A1
(43) Pub. Date: Jun. 3, 2010

(54) PLASMA DISPLAY DEVICE

(76) Inventors: Mitsuhiro Murata, Hyogo (JP); Kaname Mizokami, Kyoto (JP); Toshikazu Wakabayashi, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/598,485

(22) PCT Filed: Apr. 14, 2009
(86) PCT No.: PCT/JP2009/001703

§ 371 Date: Nov. 2, 2009

(30) Foreign Application Priority Data
Apr. 18, 2008 (JP) 2008-108592

(51) Int. Cl. G09G 3/28; G06F 3/038

(52) U.S. Cl. 345/211; 345/63

(57) ABSTRACT

Protective layer of front plate of the plasma display panel is formed of base protective layer and particle layer. Base protective layer is a thin film containing metal oxide. Particle layer is formed in a manner that aggregated particles of a plurality of magnesium-oxide single-crystal particles are stuck on base protective layer. The panel driving circuit drives the panel in a manner that an initializing discharge for forming wall charge is generated in a first subfield of the plurality of subfields, and an address discharge for erasing wall charge is generated in an address period of the plurality of subfields.

### TECHNICAL FIELD

The present invention relates to a plasma display device as an image display device using a plasma display panel.

### BACKGROUND ART

Among thin-type image display elements, a plasma display panel (hereinafter simply referred to as a panel) has become practical as a large-screen display device from the advantage of high-speed display performance and easy upsizing.

A panel is formed of a front plate and a back plate attached with each other. The front plate has a glass substrate, display electrode pairs of scan electrodes and sustain electrodes disposed on the glass substrate, a dielectric layer formed so as to cover the display electrode pairs, and a protective layer disposed on the dielectric layer. The protective layer not only protects the dielectric layer from ion collision but also promotes generation of a discharge.

The back plate has a glass substrate, data electrodes formed on the glass substrate, a dielectric layer that covers the data electrodes, barrier ribs formed on the dielectric layer, and phosphor layers that emit light in red, green, and blue. The front plate and the back plate are oppositely disposed in a manner that the display electrode pairs and the data electrodes cross each other via a discharge space. The two plates are sealed at the peripheries with low-melting glass. The discharge space is filled with discharge gas including xenon. Discharge cells are formed at positions where the display electrode pairs face the data electrodes.

With a panel structured above, a plasma display device generates a gas discharge selectively in each discharge cell of the panel. Ultraviolet light generated at the discharge excites phosphors to emit light in red, green, and blue. Color image display is thus attained.

As a method for displaying image in a plasma display device with the panel above, a subfield method is generally used. According to the method, one field period is divided into a plurality of subfields having predetermined luminance weight, and image display is attained by combination of subfields to be lit and subfields to be unlit.

However, when the control of lit cell and unlit cell is carried out on a subfield basis, a noticeable contour-shaped turbulence in gradation display known as false contours occur when a panel shows dynamic picture image. To suppress the false contours, for example, Patent Literature 1 has a suggestion in which subfields for the discharge cells to be lit are successively disposed, and similarly, subfields for the discharge cells to be unlit are successively disposed. False contours can be suppressed by the method, but has a problem of difficulty in smooth gradation display due to a limited level of gradation.

Increase in number of subfields that form one field period provides image display with a smooth gradation. According to the subfield method described above, one field period is formed of a plurality of subfields each of which has an initializing period, an address period, and a sustain period. Gradation display is attained by combination of the subfields to be lit. To increase the number of subfields forming one field period, address operations have to be completed with reliability within a short period. To address above, manufacturers have been working on the development of a panel driven at a high speed and seeking of improved driving method and driving circuits for providing high quality image so as to get best performance from the panel.

Discharge characteristics of a panel largely depend on the characteristic of a protective layer. In particular, the performance of electron emission and charge retention greatly affect the high-speed driving of a panel. To improve above, many studies on the material, structure, and manufacturing method for the protective layer have been made. For example, Patent Literature 2 discloses a plasma display panel with improvements in the panel and the electrode driving circuit. According to the disclosure, the panel has a magnesium oxide layer that exhibits a cathode luminescence emission peak at 200 to 300 nm. The magnesium oxide layer is generated through gas-phase oxidation of magnesium vapor. Besides, according to the electrode driving circuit above, scan pulses are sequentially applied to one of the display electrode pairs that constitute entire display lines, and at the same time, address pulses suitable for the display lines that undergo the application of scan pulses are applied to the data electrodes.

Recently, in addition to up sizing the screen, there has been growing demand for a high-definition plasma display device with increased lines and high quality in image display; meanwhile, a sufficient number of subfields is necessary for smooth gradation display. Such a demanding situation requires the period for address operations per line to be further shortened. To complete address operations with reliability in a limited period, manufacturers are searching for an advanced panel with more reliable address operations at higher speed than before, a driving method thereof, and a plasma display device with driving circuits controllable the panel and suitable for the method.

[Patent Literature 1] Unexamined Japanese Patent Publication No. H11-305726

[Patent Literature 2] Unexamined Japanese Patent Publication No. 2006-54158

### SUMMARY OF THE INVENTION

The plasma display device of the present invention has a panel and a panel driving circuit. The panel contains a front plate, a back plate disposed opposite to the front plate, and discharge cells formed therebetween. The front plate has a first glass substrate, display electrode pairs formed on the first glass substrate, a dielectric layer formed so as to cover the display electrode pairs, and a protective layer formed on the dielectric layer. The back plate has a second glass substrate and data electrodes formed on the second glass substrate. The discharge cells are formed at which the display electrode pairs face the data electrodes. The panel driving circuit drives the panel in a manner that one field period is temporally divided into a plurality of subfields. The protective layer is formed of a base protective layer and a particle layer. The base protective layer is a thin film containing metallic oxide. The particle layer is formed in a manner that aggregated particles of a plurality of single-crystal particles of magnesium oxide are stuck to the base protective layer. The panel driving circuit drives the panel in a manner that an initializing discharge for forming wall charge is generated in the first subfield of a plurality of subfields and an address discharge for erasing wall charge in an address period of the plurality of subfields.

### BRIEF DESCRIPTION OF THE DRAWINGS

FIG. 1 is an exploded perspective view of the structure of a panel in accordance with a first exemplary embodiment of the present invention.

FIG. 2 is a sectional view of the structure of the front plate of the panel.

FIG. 3 shows an example of aggregated particles of the panel.

FIG. 4 shows electron emission performance and charge retention performance of the panel and other trial panels.

FIG. 5A shows the result of experiment on the electron emission performance with changes in particle diameter of single-crystal particles of the trial panels.

FIG. 5B shows the relation between the particle diameter of the single-crystal particles and breakage of barrier ribs of the trial panels.

FIG. 6 is a diagram that shows an electrode array of the panel in accordance with the first exemplary embodiment of the present invention.

FIG. 7 is a waveform chart of driving voltage applied to each electrode of the panel.

FIG. 8 is a diagram that shows an electrode array of the panel in accordance with a second exemplary embodiment of the present invention.

FIG. 9 is a waveform chart of driving voltage applied to each electrode of the panel.

FIG. 10 is a circuit block diagram of the plasma display device in accordance with the first and the second exemplary embodiments of the present invention.

FIG. 11 is a circuit diagram showing the scan electrode driving circuit and the sustain electrode driving circuit of the plasma display device.

### REFERENCE MARKS IN THE DRAWINGS

10 panel
20 front plate
21 (first) glass substrate
22 scan electrode
22a, 23a transparent electrode
22b, 23b bus electrode
23 sustain electrode
24 display electrode pair
25 dielectric layer
26 protective layer
26a base protective layer
26b particle layer
27 single-crystal particle
28 aggregated particle
30 back plate
31 (second) glass substrate
32 data electrode
34 barrier rib
35 phosphor layer
41 image signal processing circuit
42 data electrode driving circuit
43 scan electrode driving circuit
44 sustain electrode driving circuit
45 timing generating circuit
50, 80 sustain pulse generating circuit
60 initializing waveform generating circuit
70 scan pulse generating circuit
100 plasma display device

### DETAILED DESCRIPTION OF THE PREFERRED EMBODIMENTS

Hereinafter, a plasma display device of an exemplary embodiment of the present invention will be described with reference to the accompanying drawings.

### First Exemplary Embodiment

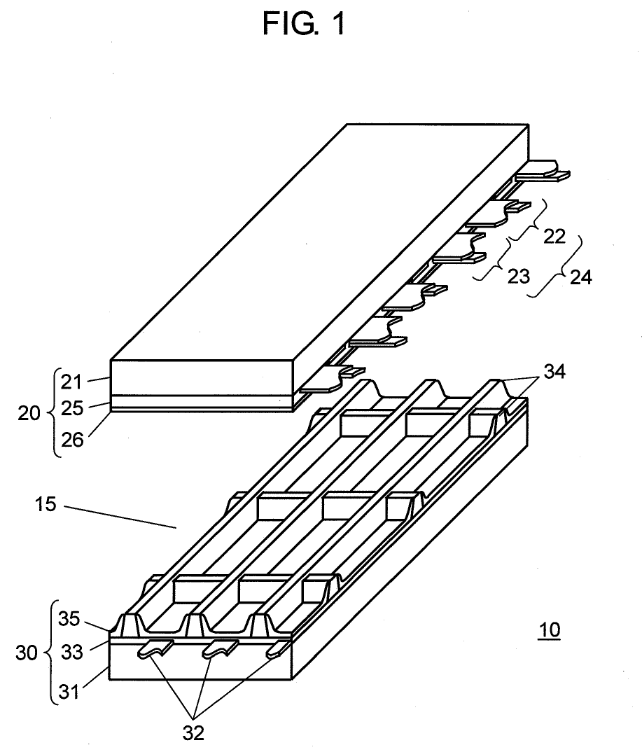

FIG. 1 is an exploded perspective view showing the structure of panel 10 in accordance with the exemplary embodiment of the present invention. Panel 10 has a structure in which front plate 20 is disposed opposite to back plate 30 and the two plates are sealed at the outer peripheries with sealing material of low-melting glass. Discharge space 15 inside panel 10 is filled with discharge gas of, for example, xenon, with a charged pressure of 400 to 600 Torr.

On glass substrate (first glass substrate) 21 of front plate 20, display electrode pairs formed of scan electrodes 22 and sustain electrodes 23 are disposed in parallel, and over which, dielectric layer 25 is formed so as to cover display electrode pairs 24. Protective layer 26 having magnesium oxide as a major component is formed on dielectric layer 25.

On glass substrate (second glass substrate) 31 of back plate 30, a plurality of data electrodes 32 are disposed in parallel in a direction orthogonal to display electrode pairs 24. Data electrodes 32 are covered with dielectric layer 33. Barrier ribs 34 are formed on dielectric layer 33. Phosphor layers 35, which emit light in red, green, and blue by ultraviolet light, are formed on dielectric layer 33 and on the side surface of barrier ribs 34. The discharge cells are formed at intersections of display electrode pairs 24 and data electrodes 32. A set of discharge cells having red, green, and blue phosphor layers 35 forms a pixel for color display. Dielectric layer 33 is not necessarily needed for the panel, and may be omitted from the structure of the panel.

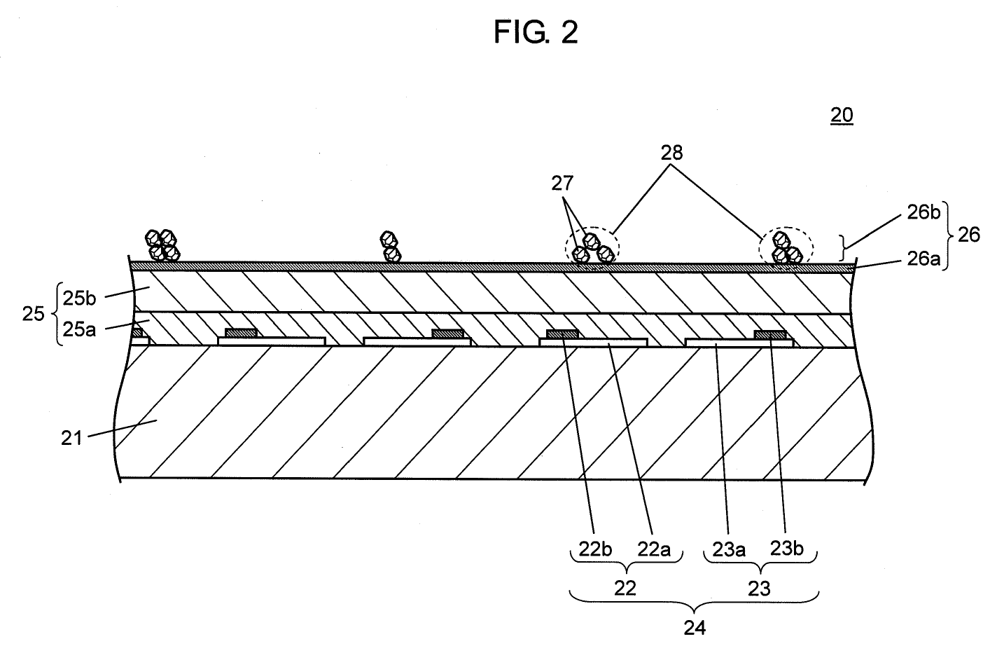

FIG. 2 is a section view showing the structure of front plate 20 of panel 10 in accordance with the exemplary embodiment of the present invention. FIG. 2 is an upside-down view of front plate 20 of FIG. 1. Display electrode pairs 24 formed of scan electrodes 22 and sustain electrodes 23 are formed on glass substrate 21. Each scan electrode 22 is formed of transparent electrode 22a and bus electrode 22b disposed on transparent electrode 22a. Transparent electrodes 22a are made of indium tin oxide, tin oxide, and the like. Similarly, each sustain electrode 23 is formed of transparent electrode 23a and bus electrode 23b disposed on transparent electrode 23a. Bus electrodes 22b, 23b are made of conductive material containing silver as a major component, which allows transparent electrodes 22a, 23a to have conductivity in its lengthwise direction.

Dielectric layer 25 has a two-layer structure formed of first dielectric layer 25a and second dielectric layer 25b. First dielectric layer 25a is formed to cover transparent electrodes 22a, transparent electrodes 23a, bus electrodes 22b, and bus electrodes 23b. Second dielectric layer 25b is formed on first dielectric layer 25a. However, dielectric layer 25 does not need to have a two-layer structure, and may be structured to have a single layer, or three or more layers.

Protective layer 26 is formed on dielectric layer 25. Details on protective layer 26 will be described below. Protective layer 26 protects dielectric layer 25 from ion collision, at the same time, it enhances performance of electron emission and charge retention, which have a great influence on the driving speed of a panel. Protective layer 26 is formed of base protective layer 26a disposed on dielectric layer 25 and particle layer 26b on base protective layer 26a.

Base protective layer 26a is a thin film predominantly composed of magnesium oxide, and has a thickness in the range of 0.3 to 1.0 μm, for example.

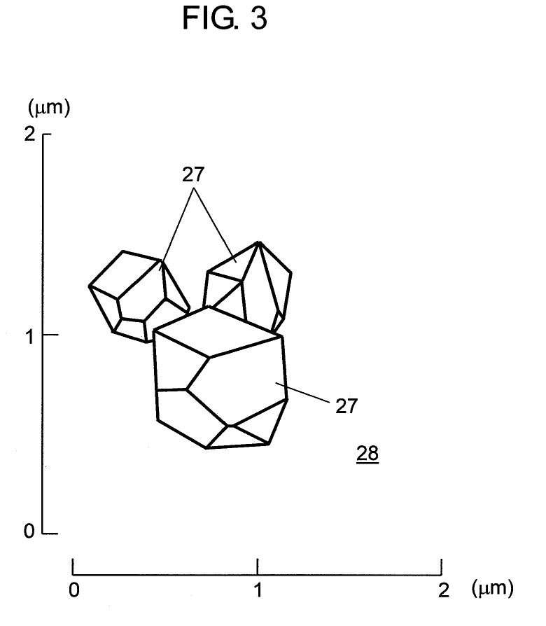

Particle layer 26b is formed in a manner that aggregated particles 28 of a plurality of magnesium-oxide single-crystal particles 27 are discretely stuck to the entire surface of base protective layer 26a so as to have uniform distribution. FIG. 2 is an enlarged view of aggregated particles 28. FIG. 3 is a diagram showing an example of aggregated particles 28 of panel 10 in accordance with the exemplary embodiment of the present invention. Aggregated particles 28 are in a state where a plurality of single-crystal particles 27 are aggregated or necked in this manner. The plurality of single-crystal particles 27 are formed into an aggregate by static electricity, van der Waals force, or the like. Preferably, single-crystal particles 27 are shaped into a polyhedron having at least seven faces, such as a tetradecahedron and dodecahedron, and have particle diameters ranging from approximately 0.9 to 2.0 μm. Preferably, in aggregated particles 28, two to five single-crystal particles 27 are aggregated. Preferably, aggregated particles 28 have particle diameters ranging from approximately 0.3 to 5 μm.

Single-crystal particles 27 and aggregated particles 28 made of the aggregated single-crystal particles that satisfy the above conditions can be produced in the following manner. When a magnesium oxide precursor, such as magnesium carbonate and magnesium hydrate, is fired to provide particles, the particle diameter can be controlled approximately in a range of 0.3 to 2 μm by setting a relatively high temperature of at least 1000° C. Further, firing the magnesium oxide precursor can provide aggregated particles 28 in which single-crystal particles 27 are aggregated or necked with each other.

Next, a description is provided on an advantageous effect of the above protective layer 26. In order to demonstrate the advantageous effect of protective layer 26 of the exemplary embodiment, trial panels that include three types of protective layer different in structure are fabricated, and the discharge characteristics thereof are examined. A first type of trial panel includes a protective layer that has only base protective layer 26a made of a thin film predominantly composed of magnesium oxide. A second type of trial panel has thin-film base protective layer 26a predominantly composed of magnesium oxide, and single-crystal particles 27 that are made of magnesium oxide and stuck to the base protective layer by spraying instead of aggregation. A third type of trial panel is the panel of the exemplary embodiment. Aggregated particles 28, which is an aggregate of magnesium-oxide single-crystal particles 27, are discretely stuck to thin-film base protective layer 26 predominantly composed of magnesium oxide so as to be substantially uniformly distributed over the entire surface.

Electron emission performance and charge retention performance are examined for these three types of panel. When the electron emission performance is higher, discharge is more likely to occur and the discharge delay is smaller. Thus, for the three types of panel, the discharge delay time is measured for estimation of statistical delay time. Numerical value K, a value obtained by integrating the inverse number of the statistical delay time, is set as a numerical value indicating the electron emission performance of each panel. Therefore, a panel having larger value K has higher electron emission performance.

For a panel having lower charge retention performance, the scan pulse voltage applied to scan electrodes 22 to compensate for the electric charge and the address pulse voltage applied to data electrodes 32 need to be increased, in a panel driving method to be described later. Thus minimum voltage Vmin of scan pulses necessary for driving each panel is used as a numerical value indicating the charge retention performance. Therefore, a panel having lower voltage Vmin has higher charge retention performance.

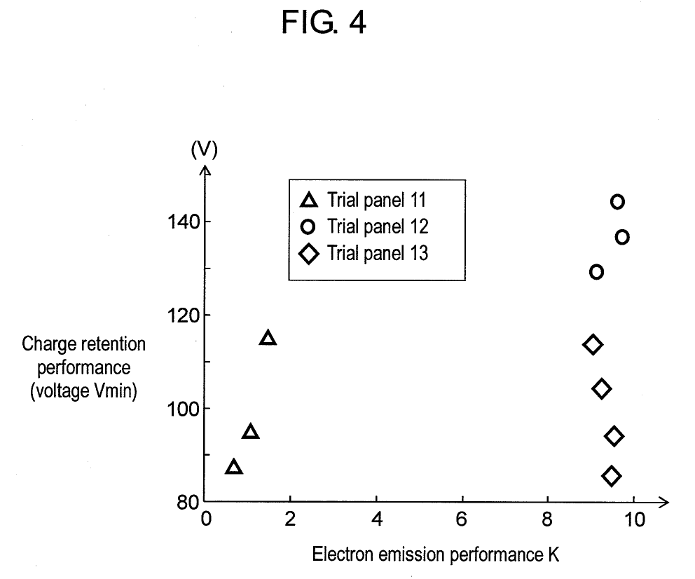

FIG. 4 is a graph that shows electron emission performance and charge retention performance of the three types of trial panel 11 through trial panel 13 including the panel of the exemplary embodiment. The first type, trial panel 11, has low voltage Vmin and low numerical value K. Thus the panel has high charge retention performance but low electron emission performance. The second type, trial panel 12, has high voltage Vmin and high numerical value K. Thus the panel has high electron emission performance but low charge retention performance.

In contrast, the third type, trial panel 13, of the exemplary embodiment has low voltage Vmin and high numerical value K. Thus the panel has excellent characteristics, i.e. high electron emission performance and high charge retention performance. Protective layer 26 has thin-film base protective layer 26a predominantly composed of magnesium oxide, and particle layer 26b. Particle layer 26b is formed in a manner that aggregated particles 28, which is an aggregate of magnesium-oxide single-crystal particles 27, are stuck onto base protective layer 26a so as to be uniformly distributed over the entire surface of the base protective layer. With this structure, panel 10 having excellent characteristics, i.e. high electron emission performance and high charge retention performance, can be provided.

Next, the particle diameter of single-crystal particle 27 is described. In the following descriptions, the particle diameter means a median diameter.

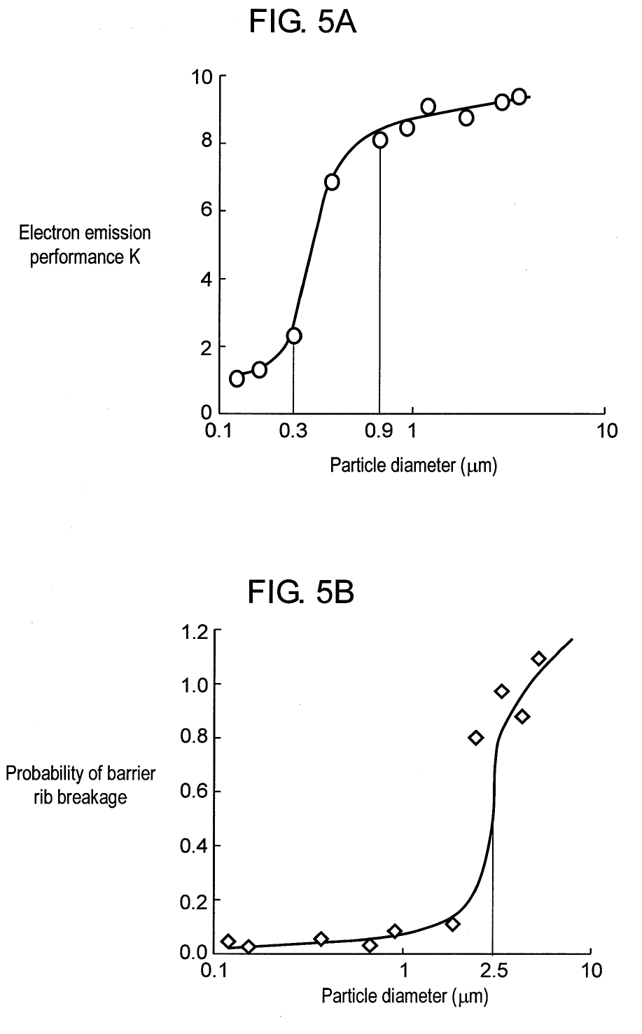

FIG. 5A is a graph showing the result of experiment on electron emission performance with changes in particle diameter of single-crystal particles 27 of trial panel 13. The particle diameters of single-crystal particles 27 are measured through microscopic observation. According to the experiments, for a particle diameter of single-crystal particle 27 as small as approximately 0.3 μm, the electron emission performance is low. For a particle diameter of approximately 0.9 μm or larger, high electron emission performance can be obtained. However, the inventors have demonstrated the following fact based on the experiments. When single-crystal particles 27 having large particle diameters exist in positions that make contact with the top parts of barrier ribs 34 of back plate 30, the probability of breakage of the top parts of barrier ribs 34 is higher. FIG. 5B is a graph showing the relation between the particle diameter of single-crystal particles 27 of trial panel 13 and breakage of barrier ribs 34. As shown in the graph, when the particle diameter of single-crystal particles 27 reaches as large as approximately 2.5 μm, the probability of barrier rib breakage is suddenly increased. In contrast, for a crystal particle diameter smaller than 2.5 μm, the probability of barrier rib breakage can be suppressed relatively low.

According to the above results, it is considered that the particle diameters of single-crystal particles 27 in the range of 0.9 to 2.5 μm are preferable. However, in consideration of variations in production, for example, it is preferable to use aggregated particles 28 that are made of single-crystal particles 27 having particle diameters in the range of 0.9 to 2 μm. Employing such structured protective layer 26 allows panel 10 to have excellent characteristics, i.e. high electron emission performance and high charge retention performance without risk of breakage of barrier ribs 34.

In the exemplary embodiment, a description is provided of panel 10 that includes thin-film base protective layer 26a predominantly composed of magnesium oxide. The present invention is not limited to this structure. Protective layer 26 is disposed to protect dielectric layer 25 from ion collision and to facilitate generation of discharge. In the exemplary embodiment, protective layer 26 is made of base protective layer 26a and particle layer 26b. Base protective layer 26a mainly serves to protect dielectric layer 25. Particle layer 26b mainly serves to facilitate generation of discharge. For this purpose, base protective layer 26a may be formed of magnesium oxide containing aluminum, aluminum oxide, and other materials that contain metal oxide having high resistance to sputtering. The material usable as single-crystal particles 27 forming particle layer 26b is magnesium oxide that contains strontium, calcium, barium, aluminum, or the like. Particle layer 26b may be formed of single-crystal particles predominantly composed of strontium oxide, calcium oxide, barium oxide, or the like.

Next, a description is provided on a method for driving panel 10 of the exemplary embodiment.

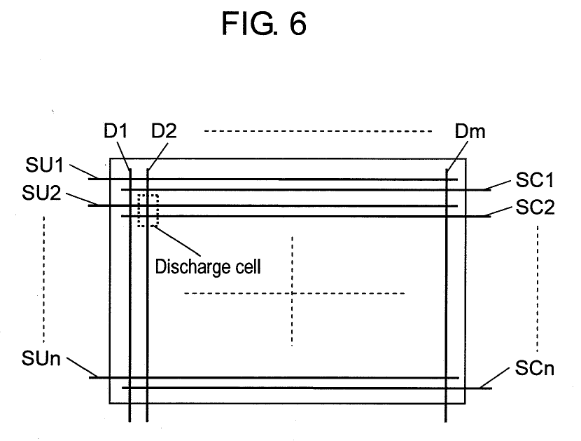

FIG. 6 shows an electrode array on panel 10 in accordance with the embodiment of the present invention. In a row (line) direction, panel 10 has n long scan electrodes SC1 through SCn (corresponding to scan electrodes 22 in FIG. 1) and n long sustain electrodes SU1 through SUn (corresponding to sustain electrodes 23 in FIG. 1). In a column direction, panel 10 has m long data electrodes D1 through Dm (corresponding to data electrodes 32 in FIG. 1). A discharge cell is formed at an intersection of a pair of scan electrode SCi and sustain electrode SUi (where, i is 1 through n) and data electrode Dj (where, j is 1 through m). That is, panel 10 contains m×n discharge cells in the discharge space. For example, a panel used for a high-definition plasma display device has the following number of discharge cells: m=1920×3=5760 and n=1080.

Next will be described waveforms of driving voltage for driving panel 10. Panel 10 is driven by a subfield method in which a plurality of subfields are temporally disposed to form one field period. That is, one field period is divided into a plurality of subfields, and light emission and no light emission of the respective discharge cells are controlled on a subfield basis. Each subfield has an initializing period and an address period. The first subfield has an initializing period.

In the initializing period, an initializing discharge is generated to form wall charge necessary for a sustain discharge for lighting the discharge cells. At this time, wall charge necessary for an address discharge are also formed. In the address period, an address discharge is generated in the discharge cells to be unlit so as to erase the wall charge necessary for a sustain discharge. In the sustain period, sustain pulses corresponding in number to luminance weight are applied alternately to the display electrode pairs. Thereby, a sustain discharge is generated in the discharge cells having undergone no address discharge, and the discharge cells are lit.

In this manner, the driving method of the exemplary embodiment is characterized in that an initializing period is set in the first subfield, no initializing period is set in the subfields thereafter, and an address operation is performed in the discharge cells to be unlit. In the initializing period of the first subfield, an initializing operation is performed. In the discharge cells undergoing no address operation thereafter, a sustain discharge is successively generated for light emission. In the discharge cells having undergone an address operation once, no sustain discharge is generated until the next initializing operation is performed. Among the subfield methods, such a driving method for gradation display by the above control—in which discharge cells to be lit and discharge cells to be unlit have a successive arrangement—is simply referred to “successive driving method” hereinafter.

According to the embodiment, one field is divided into 14 subfields (the first SF, the second SF, . . . , the 14th SF), and each subfield has, for example, following luminance weight: 1, 1, 1, 1, 3, 5, 5, 8, 16, 16, 20, 22, 28, and 64. The first SF is the subfield that has an initializing period. Each of the second SF through the 14th SF is the subfield that has no initializing period. Hereinafter, the successive driving method of the exemplary embodiment is detailed.

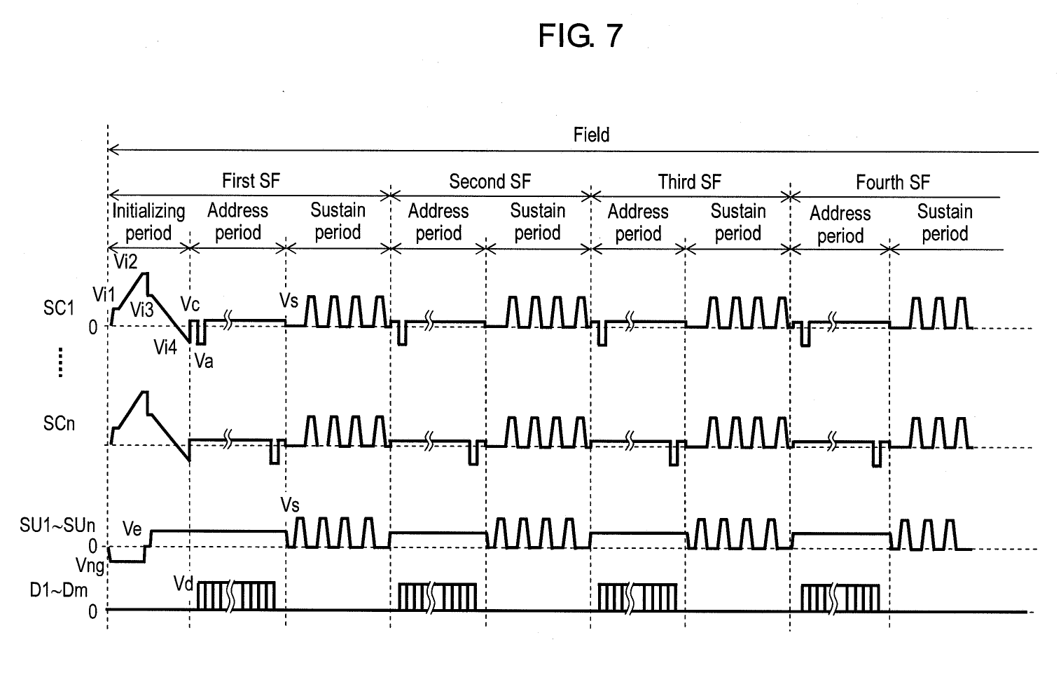

FIG. 7 is a waveform chart of driving voltage applied to each electrode of panel 10 of the first exemplary embodiment. First, description is provided on the first SF that has an initializing period.

In the first half of the initializing period of the first SF, 0 (V) is applied to data electrodes D1 through Dm and voltage Vng is applied to sustain electrodes SU1 through SUn. An up-ramp waveform voltage is applied to scan electrodes SC1 through SCn. The up-ramp waveform voltage gradually increases, starting from voltage Vi1 that is lower than the discharge start voltage with respect to sustain electrodes SU1 through SUn, toward voltage Vi2 that exceeds the discharge start voltage.

During the application of the up-ramp voltage, a weak initializing discharge occurs between scan electrodes SC1 through SCn and sustain electrodes SU1 through SUn, and between scan electrodes SC1 through SCn and data electrodes D1 through Dm. Through the initializing discharge, negative wall voltage is accumulated on scan electrodes SC1 through SCn, and positive wall voltage is accumulated on data electrodes D1 through Dm and sustain electrodes SU1 through SUn. The wall voltage on each electrode represents a voltage generated by wall charge accumulated, for example, on the dielectric layer, on the protective layer, and on the phosphor layer disposed over the electrodes. In the initializing discharge above, an excessive amount of wall charges is accumulated prior to the latter half of the initializing period where wall voltage is optimized to a proper value.

In the latter half of the initializing period, voltage Ve is applied to sustain electrodes SU1 through SUn. A down-ramp waveform voltage is applied to scan electrodes SC1 through SCn. The down-ramp waveform voltage gradually decreases, starting from voltage Vi3 that is lower than the discharge start voltage with respect to sustain electrodes SU1 through SUn, toward voltage Vi4 that exceeds the discharge start voltage. During the application of voltage, a weak initializing discharge between scan electrodes SC1 through SCn and sustain electrodes SU1 through SUn, and between scan electrodes SC1 through SCn and data electrodes D1 through Dm. This weak discharge optimizes the excess negative wall voltage on scan electrodes SC1 through SCn and the excess positive wall voltage on sustain electrodes SU1 through SUn, and thus forms wall charge necessary for the sustain discharge. Similarly, the excess positive wall voltage on data electrodes D1 through Dm is optimized so that wall charge necessary for the address discharge is formed. The initializing operation is thus completed.

In the subsequent address period, voltage Ve is applied to sustain electrodes SU1 through SUn and voltage Vc is applied to scan electrodes SC1 through SCn. Next, negative scan pulse voltage Va is applied to scan electrode SC1 located in the first line. At the same time, positive address pulse voltage Vd is applied to data electrode Dk (k is 1 through m) corresponding to the discharge cell to be unlit in the first line, among data electrodes D1 through Dm. At this time, difference in voltage at the intersection of data electrode Dk and scan electrode SC1 is calculated by adding the difference in wall voltage between data electrode Dk and scan electrode SC1 to the difference in voltage applied from outside (i.e., Vd−Va). The calculated value exceeds the discharge start voltage, thereby generating an address discharge between data electrode Dk and scan electrode SC1, and between sustain electrode SU1 and scan electrode SC1. Through the address discharge, the wall voltage on scan electrode SC1 and on sustain electrode SU1 is erased. The erasure of the wall voltage at this time means that the wall voltage is reduced so that no sustain discharge occurs in the sustain period to be described later.

Here, the time after application of scan pulse voltage Va and address pulse voltage Vd until generation of an address discharge is referred to as “discharge delay time”. For a panel having low electron emission performance and thus long discharge delay time, the time periods during which scan pulse voltage Va and address pulse voltage Vd are applied for a reliable address operation, i.e. a scan pulse width and an address pulse width, need to be set longer. Thus the address operation cannot be performed at high speed. For a panel having low charge retention performance, the values of scan pulse voltage Va and address pulse voltage Vd need to be set higher to compensate for a decrease in the wall voltages. However, panel 10 of the exemplary embodiment has high electron emission performance. Thus the scan pulse width and address pulse width can be set shorter than those of a conventional panel and the address operation can be performed stably at high speed. Further, panel 10 of the exemplary embodiment has high charge retention performance. Thus the values of scan pulse voltage Va and address pulse voltage Vd can be set lower than those of a conventional panel.

In this manner, the address operation is performed to cause the address discharge in the discharge cells to be unlit in the first line and to erase wall voltages on the corresponding electrodes. In contrast, the voltage in the intersecting parts between data electrodes D1 through Dm applied with no address pulse voltage Vd and scan electrode SC1 do not exceed the discharge start voltage. Thus no address discharge occurs, and the wall voltage at the completion of the initializing period is maintained. The above address operation is repeated until the discharge cells in the n-th line, and the address period is completed.

In the subsequent sustain period, first, 0(V) is applied to scan electrodes SC1 through SCn, and positive sustain pulse voltage Vs is applied to sustain electrodes SU1 through SUn. Then, in the discharge cells having undergone no address discharge, the voltage difference between sustain electrode SUi and scan electrode SCi is obtained by adding sustain pulse voltage Vs to the difference between the wall voltage on sustain electrode SUi and the wall voltage on scan electrode SCi. The calculated value exceeds the discharge start voltage.

Through the application of voltage above, a sustain discharge occurs between scan electrode SCi and sustain electrode SUi, and ultraviolet light generated at this time causes phosphor layers 35 to emit light. Thus positive wall voltage accumulates on scan electrode SCi, and negative wall voltage accumulates on sustain electrodes SUi. In the discharge cells having undergone the address discharge in the address period, no sustain discharge occurs.

Subsequently, a sustain discharge occurs between scan electrode SCi and sustain electrode SUi, and ultraviolet light generated at this time causes phosphor layers 35 to emit light. Thus positive wall voltage accumulates on scan electrode SCi, and negative wall voltage accumulates on sustain electrodes SUi. In the discharge cells having undergone the address discharge in the address period, no sustain discharge occurs.

Next, sustain pulse voltage Vs is applied to scan electrodes SC1 through SCn, and 0 (V) is applied to sustain electrodes SU1 through SUn. In the discharge cell having undergone the sustain discharge, the voltage difference between scan electrode SCi and sustain electrode SUi exceeds the discharge start voltage. Thereby, a sustain discharge occurs between scan electrode SCi and sustain electrode SUi again. Thus negative wall voltage accumulates on scan electrode SCi, and positive wall voltage accumulates on sustain electrode SUi.

Subsequently, sustain pulse voltage Vs is applied to scan electrodes SC1 through SCn, and 0 (V) is applied to sustain electrodes SU1 through SUn. In the discharge cell having undergone the sustain discharge, the voltage difference between scan electrode SCi and sustain electrode SUi exceeds the discharge start voltage. Thereby, a sustain discharge occurs between scan electrode SCi and sustain electrode SUi again. Thus negative wall voltage accumulates on scan electrode SCi, and positive wall voltage accumulates on sustain electrode SUi.

Similarly, sustain pulses corresponding in number to the luminance weight are applied alternately to sustain electrodes SU1 through SUn and scan electrodes SC1 through SCn to cause a potential difference between the electrodes of the display electrode pairs. Thus the sustain discharge continues in the discharge cells having undergone no address discharge in the address period.

The subsequent second SF is a subfield that has no initializing period. In the address period of the second SF, voltage Ve is applied to sustain electrodes SU1 through SUn, and voltage Vc is applied to scan electrodes SC1 through SCn. Next, negative scan pulse Va is applied to scan electrode SC1 in the first line, and positive address pulse voltage Vd is applied to data electrode Dk in a discharge cell to be unlit in the first line, among data electrodes D1 through Dm.

In the discharge cells having undergone a sustain discharge in the immediately preceding first SF, an address discharge occurs between data electrode Dk and sustain electrode SC1, and between sustain electrode SU1 and scan electrode SC1. Thus the wall voltage on scan electrode SC1 and the wall voltage on sustain electrode SU1 are erased. In this manner, an address operation is performed to cause an address discharge in the discharge cells to be unlit in the first line and to erase the wall voltages on the corresponding electrodes. In contrast, in the discharge cells having undergone an address discharge in the address period after the initializing period and having undergone no sustain discharge in the immediately preceding first SF, the voltage does not exceed the discharge start voltage. Similarly, the voltage at the intersecting parts between data electrodes D1 through Dm and scan electrode SC1 in the discharge cells applied with no address pulse voltage Vd does not exceed the discharge start voltage. Thus no address discharge occurs in these cells. After the address operation above is repeatedly carried out until the discharge cells in the n-th line, the address period is completed.

In the subsequent sustain period, 0 (V) is applied to scan electrodes SC1 through SCn, and positive sustain pulse voltage Vs is applied to sustain electrodes SU1 through SUn. Then, in the discharge cells having undergone a sustain discharge in the sustain period of the immediately preceding first SF and having undergone no address discharge, a sustain discharge occurs between scan electrode SCi and sustain electrode SUi. Thus the corresponding cells are lit. In the discharge cells having undergone an address discharge in the address period after the initializing period and having undergone no sustain discharge in the immediately preceding first SF, or the discharge cells having undergone an address discharge, no sustain discharge occurs.

Subsequently, sustain pulse voltage Vs is applied to scan electrodes SC1 through SCn, and 0 (V) is applied to sustain electrode SU1 through SUn. Then, in the discharge cells having undergone a sustain discharge, a sustain discharge occurs again. Thus positive wall voltage is accumulated on sustain electrode SUi, and negative wall voltage is accumulated on scan electrode SCi. Thereafter, similarly, a number of sustain pulses corresponding in number to a luminance weight are applied alternately to sustain electrodes SU1 through SUn and scan electrodes SC1 through SCn, to cause a potential difference between the electrodes of each display electrode pair. Thereby, the sustain discharge continues.

The driving voltage waveforms and the operation of the panel in the third SF through the 14th SF are substantially similar to those in the second SF except for the number of sustain pulses.

That is, in the address period of the third SF through the 14th SF, voltage Ve is applied to sustain electrodes SU1 through SUn, and voltage Vc is applied to scan electrodes SC1 through SCn. Next, negative scan pulse Va is applied to scan electrode SC1 in the first line, and positive address pulse voltage Vd is applied to data electrode Dk in a discharge cell to be unlit in the first line, among data electrodes D1 through Dm.

Then, in the discharge cells having undergone a sustain discharge in the immediately preceding subfield, an address discharge occurs. Thus the wall voltage on scan electrode SC1 and the wall voltage on sustain electrode SU1 are erased. In contrast, in the discharge cells having undergone an address discharge in the address period after the initializing period and having undergone no sustain discharge in the immediately preceding subfield, and in the discharge cells having undergone no address pulse Vd, no address discharge occurs. After the address operation above is repeatedly carried out until the discharge cells in the n-th line, the address period is completed.

In the subsequent sustain period, a number of sustain pulses corresponding in number to the luminance weight are applied alternately to sustain electrodes SU1 through SUn and scan electrodes SC1 through SCn. Then, in the discharge cells having undergone a sustain discharge in the sustain period of the immediately preceding subfield and having undergone no address discharge, a sustain discharge occurs and thus the corresponding cells are lit. In contrast, in the discharge cells having undergone an address discharge in the address period after the initializing period and having undergone no sustain discharge in the preceding subfield, or the discharge cells having undergone an address discharge, no sustain discharge occurs.

In the exemplary embodiment, scan electrodes SC1 through SCn are applied with voltage Vi1 of 130 (V), voltage Vi2 of 380 (V), voltage Vi3 of 200 (V), voltage Vi4 of −25 (V), voltage Vc of 80 (V), voltage Va of −50 (V), and voltage Vs of 200 (V). Further, sustain electrodes SU1 through SUn are applied with voltage Vng of −50 (V), voltage Ve of 50 (V), voltage Vs of 200 (V). Data electrodes D1 through Dm are applied with voltage Vd of 67 (V). The gradient of the up-ramp waveform voltage applied to scan electrodes SC1 through SCn is 1.0 V/μ, and the gradient of the down-ramp waveform voltage is −1.3V/μ. Each of the pulse widths of the scan pulse and the address pulse is 1.0 μs. However, these voltages are not limited to the above values. It is preferable to set optimum values according to the discharge characteristics of the panel and the specifications of the plasma display device.

As described above, the driving method of the exemplary embodiment is a successive driving method. That is, an initializing operation is performed in the initializing period of the first subfield. Further, in the discharge cells in which no address operation is performed thereafter, a sustain discharge is successively generated for light emission. In the discharge cells in which an address operation is performed once, no sustain discharge is generated until the next initializing operation is performed.

In this manner, in the exemplary embodiment, the address period is shortened by making full use of the performance, i.e. high electron emission performance and high-speed driving, of the panel. Further, while the number of subfields necessary for gradation display is secured, panel 10 is driven by a successive driving method. Thereby, images of high quality without false contours can be displayed.

Further, panel 10 of the exemplary embodiment has high charge retention performance. Thus the values of scan pulse voltage Va and address pulse voltage Vd can be set lower than those of a conventional panel. However, panel 10 of the exemplary embodiment still has a slight decrease in the wall charges. Thus, as the number of discharge electrode pairs is increased or the number of subfields is increased, the voltages of scan pulse voltage Va and address pulse voltage Vd tend to rise. Next, a successive driving method for suppressing the rise in these voltages is described.

### Second Exemplary Embodiment

The panel of the second exemplary embodiment of the present invention is identical in structure with panel 10 of the first exemplary embodiment, and thus the description thereof is omitted. The second exemplary embodiment largely differs from the first exemplary embodiment in the driving method of panel 10, that is, a successive driving method for suppressing a rise in voltages of scan pulse voltage Va and address pulse voltage Vd.

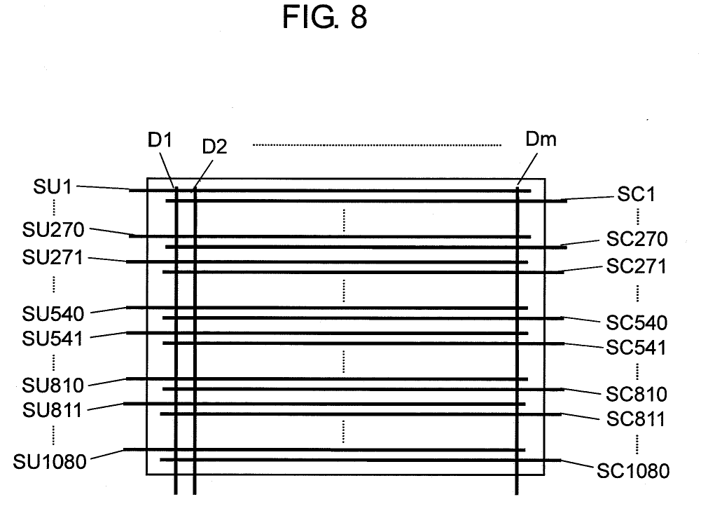

FIG. 8 is an electrode array diagram of panel 10 in accordance with the second exemplary embodiment of the present invention. The electrode array of panel 10 is identical with that of the first exemplary embodiment. Panel 10 has n scan electrodes SC1 through SCn (scan electrodes 22 in FIG. 1) and n sustain electrodes SU1 through SUn (sustain electrodes 23 in FIG. 1) both long in the row (line) direction, and m data electrodes D1 through Dm (data electrodes 32 in FIG. 1) long in the column direction. A discharge cell is formed in the part where a pair of scan electrode SCi (i is 1 through n) and sustain electrode SUi intersects with one data electrode Dj (j is 1 through m). Thus m×n discharge cells are formed in the discharge space. For example, the number of discharge cells in a panel is m=1920×3=5760 and n=1080. The number of display electrode pairs is not specifically limited. For explanation, n=1080 in the second exemplary embodiment.

Scan electrodes SC1 through SC1080 and sustain electrodes SU1 through SU1080 form 1080 pairs of display electrodes. The display electrode pairs are divided into a plurality of display electrode pair groups. According to the embodiment, they are divided into four groups in the top-to-down direction of the panel. That is, in the downward order from the electrode pairs disposed at the top of the panel, scan electrodes SC1 through SC270 and sustain electrodes SU1 through SU270 belong to the first display electrode pair group, scan electrodes SC271 through SC540 and sustain electrodes SU271 through SU540 belong to the second display electrode pair group, scan electrodes SC541 through SC810 and sustain electrodes SU541 through SU810 belong to the third display electrode pair group, and scan electrodes SC811 through SC1080 and sustain electrodes SU811 through SU1080 belong to the fourth display electrode pair group.

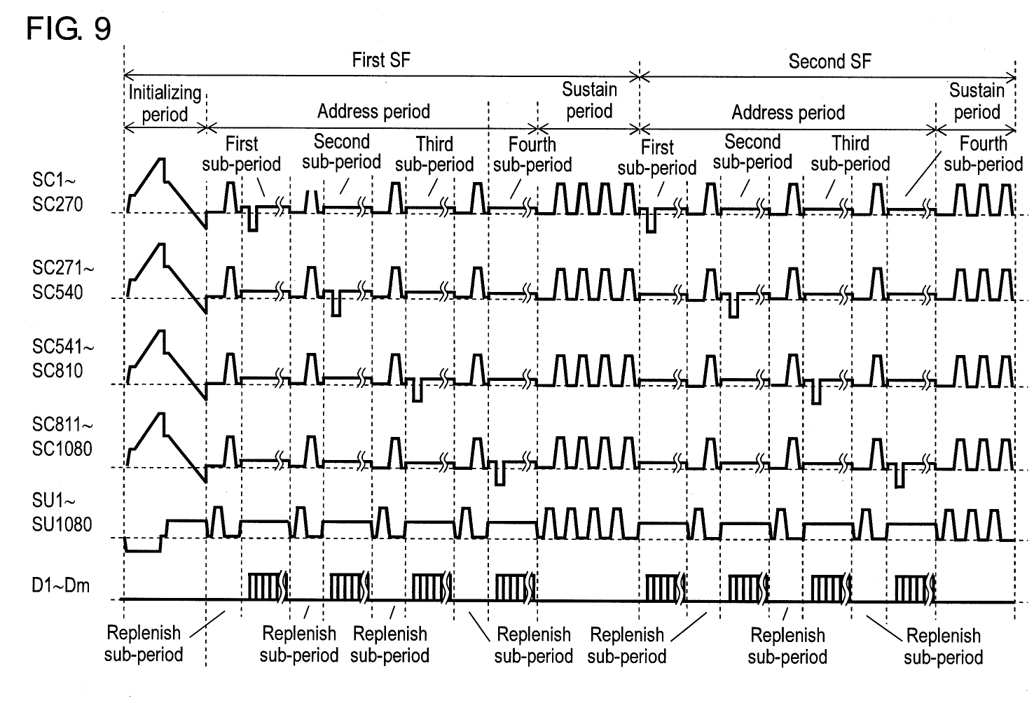

FIG. 9 shows a waveform chart of driving voltages applied to respective electrodes of panel 10 in accordance with the second exemplary embodiment. FIG. 9 shows the first SF and the second SF.

The initializing period of the first SF is similar to that of the first exemplary embodiment, and thus the description thereof is omitted.

In the subsequent address period, the address period is divided into four address sub-periods (a first sub-period, a second sub-period, a third sub-period, and a fourth sub-period) corresponding to the four display electrode pair groups. Before each address sub-period, a replenish sub-period for supplying wall charges is disposed.

In the first replenish sub-period in the address period, first, 0 (V) is applied to scan electrodes SC1 through SCn, and positive sustain pulse voltage Vs is applied to sustain electrodes SU1 through SUn. Then, a discharge occurs between scan electrode SCi and sustain electrode SUi. Sequentially, sustain pulse voltage Vs is applied to scan electrodes SU1 through SCn, and 0 (V) is applied to sustain electrodes SU1 through SUn. Then, a discharge occurs between scan electrode SCi and sustain electrode SUi again. Such a discharge (hereinafter referred to as “replenish discharge”) in the replenish sub-period is a discharge similar to a sustain discharge, and occurs irrespective of image display. Further, if the wall charge on data electrodes D1 through Dm are reduced for some causes, the wall charge on data electrodes D1 through Dm are supplied by a replenish discharge. Thus the voltages of scan pulse voltage Va and address pulse voltage Vd have no rise in the subsequent first period.

In the subsequent address period, i.e. the first sub-period, voltage Ve is applied to sustain electrodes SU1 through SUn, and voltage Vc is applied to scan electrodes SC1 through SCn. Next, scan pulse voltage Va is applied to scan electrode SC1 in the first line, and address pulse voltage Vd is applied to data electrode Dk in a discharge cell to be unlit in the first line, among data electrodes D1 through Dm. Then, an address discharge occurs between data electrode Dk and scan electrode SC1, and between sustain electrode SU1 and scan electrode SC1. Thus the wall voltage on scan electrode SC1 and the wall voltage on sustain electrode SU1 are erased. After the above address operation is repeatedly carried out until the discharge cells in the 270th line belonging to the first display electrode pair group, the first sub-period is completed.

In the subsequent replenish sub-period, first, 0 (V) is applied to scan electrodes SC1 through SCn, and positive sustain pulse voltage Vs is applied to sustain electrodes SU1 through SUn to cause a replenish discharge. Next, sustain pulse voltage Vs is applied to scan electrodes SC1 through SCn, and 0 (V) is applied to sustain electrodes SU1 through SUn to cause a replenish discharge. The number of discharge cells undergoing an address operation in the first sub-period is ¼ of the total number of discharge cells. Thus the amount of decrease in wall charges is approximately ¼ times the amount of decrease in wall charges in an address period in the driving method of the first exemplary embodiment. Before wall charges have further decreased, the wall charge on data electrodes D1 through Dm is supplied by a replenish discharge. Thus, in the succeeding second sub-period, the voltages of scan pulse voltage Va and address pulse voltage Vd have no rise.

In the subsequent address period, i.e. the second sub-period, voltage Ve is applied to sustain electrodes SU1 through SUn, and voltage Vc is applied to scan electrodes SC1 through SCn. Next, scan pulse voltage Va is applied to scan electrode SC271 in the 271st line, and address pulse voltage Vd is applied to data electrode Dk in a discharge cell to be unlit in the 271st line, among data electrodes D1 through Dm. Then, an address discharge occurs, and thus the wall voltage on scan electrode SC271 and the wall voltage on sustain electrode SU271 are erased. The above address operation is repeated in the discharge cells in the 271st line to the 540th line belonging to the second display electrode pair group, and the second sub-period is completed.

In the subsequent replenish sub-period, first, 0 (V) is applied to scan electrodes SC1 through SCn, and positive sustain pulse voltage Vs is applied to sustain electrodes SU1 through SUn to cause a replenish discharge. Next, sustain pulse voltage Vs is applied to scan electrodes SC1 through SCn, and 0 (V) is applied to sustain electrodes SU1 through SUn to cause a replenish discharge. The number of discharge cells undergoing an address operation in the second sub-period is ¼ of the total number of discharge cells. Thus the amount of decrease in wall charges is approximately ¼ times the amount of decrease in the wall charges in an address period in the driving method of the first exemplary embodiment. Before wall charges have further decreased, the wall charge on data electrodes D1 through Dm are supplied by a replenish discharge. Thus, in the succeeding third sub-period, the voltages of scan pulse voltage Va and address pulse voltage Vd have no rise.

In the subsequent third sub-period, voltage Ve is applied to sustain electrodes SU1 through SUn, and voltage Vc is applied to scan electrodes SC1 through SCn. Next, scan pulse voltage Va is applied to scan electrode SC541 in the 541st line, and address pulse voltage Vd is applied to data electrode Dk in a discharge cell to be unlit in the 541st line, among data electrodes D1 through Dm. Then, an address discharge occurs, and thus the wall voltage on scan electrode SC541 and the wall voltage on sustain electrode SU541 are erased. The above address operation is repeated in the discharge cells in the 541st line to the 810th line belonging to the third display electrode pair group, and the third sub-period is completed.

In the subsequent replenish sub-period, as is similar to the other replenish sub-periods, first, 0 (V) is applied to scan electrodes SC1 through SCn, and positive sustain pulse voltage Vs is applied to sustain electrodes SU1 through SUn to cause a replenish discharge. Next, sustain pulse voltage Vs is applied to scan electrodes SC1 through SCn, and 0 (V) is applied to sustain electrodes SU1 through SUn to cause a replenish discharge.

In the fourth sub-period, voltage Ve is applied to sustain electrodes SU1 through SUn, and voltage Vc is applied to scan electrodes SC1 through SCn. Next, scan pulse voltage Va is applied to scan electrode SC811 in the 811th line, and address pulse voltage Vd is applied to data electrode Dk in a discharge cell to be unlit in the 811th line, among data electrodes D1 through Dm. Then, an address discharge occurs, and thus the wall voltage on scan electrode SC811 and the wall voltage on sustain electrode SU811 are erased. The above address operation is repeated in the discharge cells in the 811th line to the 1080th line belonging to the fourth display electrode pair group. Thus the address period is completed.

The sustain period of the first SF is similar to that of the first exemplary embodiment, and thus the description thereof is omitted.

In the subsequent address period of the second SF, the address period is divided into four address sub-periods (a first sub-period, a second sub-period, a third sub-period, and a fourth sub-period) corresponding to the four display electrode pair groups. Before each address sub-period, a replenish sub-period for supplying wall charges is disposed. However, the sustain discharge in the sustain period of the first SF can be used for the replenish discharge before the first sub-period. Thus the replenish discharge is omitted in the second exemplary embodiment. The other sub-periods, i.e. a first sub-period, a replenish sub-period, a second sub-period, a replenish sub-period, a third sub-period, a replenish sub-period, and a fourth sub-period, are similar to the first sub-period, the replenish sub-period, the second sub-period, the replenish sub-period, the third sub-period, the replenish sub-period, and the fourth sub-period, respectively, in the first SF.

The sustain period of the second SF is similar to that of the first exemplary embodiment, and thus the description thereof is omitted. The sustain periods of the third SF through the 14th SF are similar to that of the second SF except for the numbers of sustain pulses.

In this manner, in the second exemplary embodiment, display electrode pairs 24 are divided into four display electrode pair groups, and the address period is divided into four address sub-periods corresponding to the four display electrode pair groups. Before address sub-periods, replenish sub-periods for supplying wall charges are disposed. Panel 10 is driven with the structure above. In this structure, the number of the discharge cells for undergoing an address operation in each address sub-period is ¼ of the total number of discharge cells. Thus the amount of decrease in wall charges is approximately ¼ times the amount of decrease in the wall charges in an address period in the driving method of the first exemplary embodiment. Before wall charges have further decreased, the wall charge on data electrodes D1 through Dm are supplied by a replenish discharge. Thus, in each of the subsequent address sub-periods, the voltages of scan pulse voltage Va and address pulse voltage Vd have no rise. As a result, a rise in these voltages can be suppressed.

In the second exemplary embodiment, panel 10 is driven in the following structure. Display electrode pairs 24 are divided into four display electrode pair groups, and each address period is divided into four address sub-periods corresponding to the four display electrode pair groups. In the first SF, before each address sub-period, a replenish sub-period for supplying wall charges is disposed. In each of the second SF through the 14th SF, replenish sub-periods for supplying wall charges are disposed before address sub-periods except the first sub-period. However, the present invention is not limited to this structure. The following structure can be used for driving the panel. According to the characteristics of the panel, for example, display electrode pairs 24 are divided into a plurality of display electrode pair groups, and each address period is divided into a plurality of address sub-periods corresponding to the plurality of display electrode pair groups. Further, a replenish sub-period for supplying wall charges is disposed before at least one of the address sub-periods.

In the description of the second exemplary embodiment, an address operation is performed on the first display electrode pair group in the first sub-period, the second display electrode pair group in the second sub-period, the third display electrode pair group in the third sub-period, and the fourth display electrode pair group in the fourth sub-period. However, the present invention is not limited to this structure. In order to make the display luminance of each display electrode pair group uniform, it is preferable to change the combination of the display electrode pair groups and the address sub-periods on a field basis. For example, in the first field, an address operation is performed on the first display electrode pair group in the first sub-period, the second display electrode pair group in the second sub-period, the third display electrode pair group in the third sub-period, and the fourth electrode pair group in the fourth sub-period. In the second field, an address operation is performed on the first display electrode pair group in the second sub-period, the second display electrode pair group in the third sub-period, the third display electrode pair group in the fourth sub-period, and the fourth display electrode pair group in the first sub-period. In the third field, an address operation is performed on the first display electrode pair group in the third sub-period, the second display electrode pair group in the fourth sub-period, the third display electrode pair group in the first sub-period, and the fourth display electrode pair group in the second sub-period. In the fourth field, an address operation is performed on the first display electrode pair group in the fourth sub-period, the second display electrode pair group in the first sub-period, the third display electrode pair group in the second sub-period, and the fourth display electrode pair group in the third sub-period. In this manner, the combination of the display electrode pair groups and the address sub-periods is cyclically changed in each field. Thereby, the display luminance of each display electrode pair group can be made uniform.

Next, a description is provided on an example of a driving circuit for generating the driving voltage waveforms described in the first exemplary embodiment and the second exemplary embodiment.

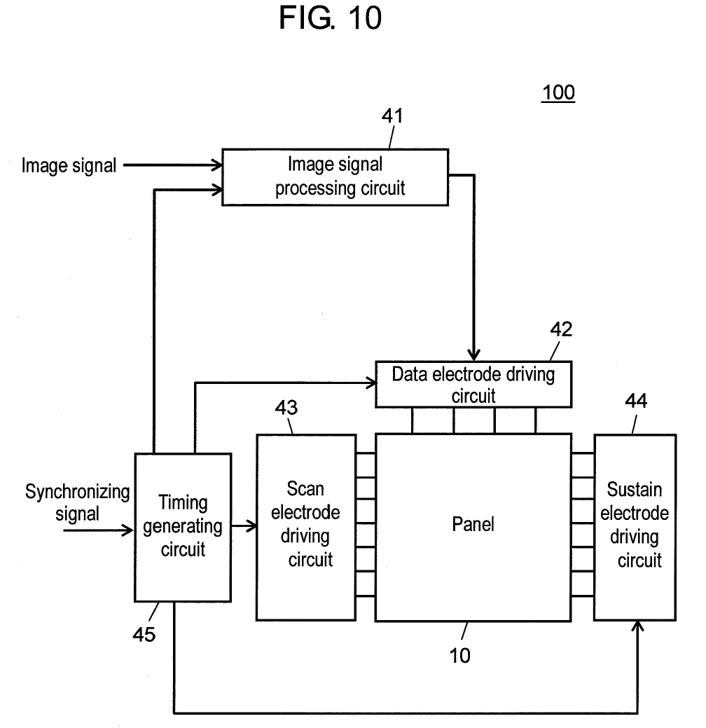

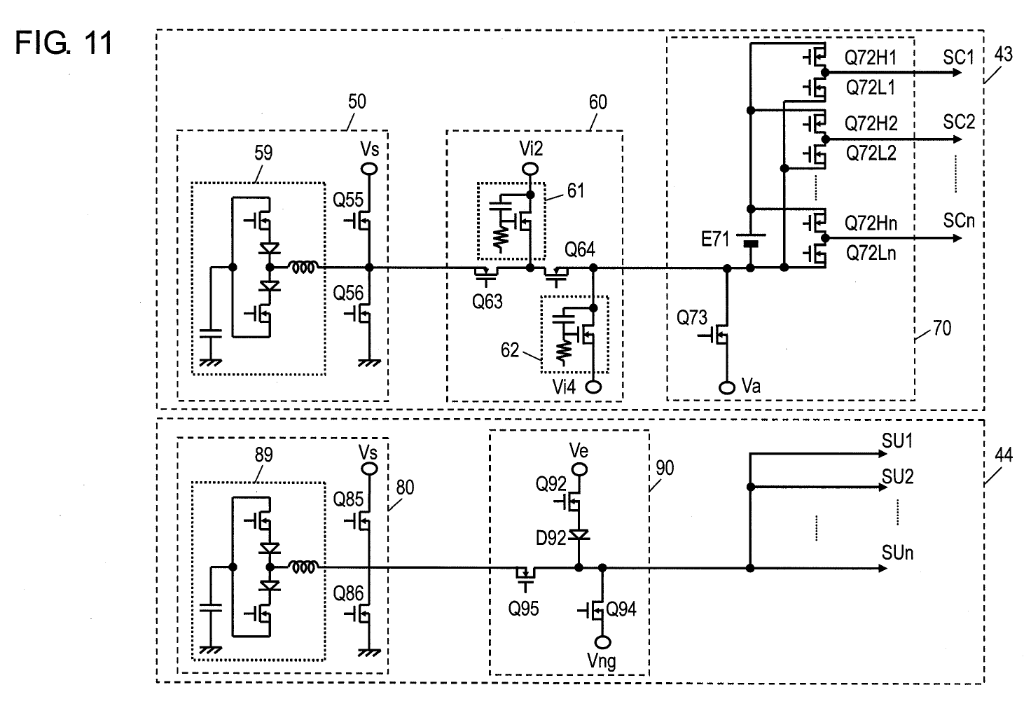

FIG. 10 is a circuit block diagram of plasma display device 100 of the embodiment. Plasma display device 100 has panel 10 and a panel driving circuit. The panel driving circuit has image signal processing circuit 41, data electrode driving circuit 42, scan electrode driving circuit 43, sustain electrode driving circuit 44, timing generating circuit 45, and a power supply circuit (not shown) for supplying power to each circuit block.

Receiving an image signal, image signal processing circuit 41 converts it into image data for light-emitting or non-light-emitting on a subfield basis. Data electrode driving circuit 42 converts the image data of each subfield into a signal for data electrodes D1 through Dm to drive them. Timing generating circuit 45 generates timing signals that control each circuit block according to a horizontal synchronizing signal and a vertical synchronizing signal. Such generated timing signals are fed to each circuit block. According to the timing signals, scan electrode driving circuit 43 drives scan electrodes SC1 through SCn. According to the timing signals, sustain electrode driving circuit 44 drives sustain electrodes SU1 through SUn.

FIG. 10 is a circuit diagram showing scan electrode driving circuit 43 and sustain electrode driving circuit 44 of plasma display device 100 of the embodiment of the present invention.

Scan electrode driving circuit 43 has sustain pulse generating circuit 50, initializing waveform generating circuit 60, and scan pulse generating circuit 70. Sustain pulse generating circuit 50 has switching element Q55 for applying voltage Vs to scan electrodes SC1 through SCn, switching element Q56 for applying 0 (V) to scan electrodes SC1 through SCn, and power recovering section 59 for recovering power for the application of sustain pulses to scan electrodes SC1 through SCn. Initializing waveform generating circuit 60 has Miller integrating circuit 61 and Miller integrating circuit 62. Miller integrating circuit 61 applies voltage having an up-ramp waveform to scan electrodes SC1 through SCn, whereas Miller integrating circuit 62 applies voltage having a down-ramp waveform to scan electrodes SC1 through SCn. Switching elements Q63, Q64 prevent backflow of electric current via a parasitic diode of other switching elements. Scan pulse generating circuit 70 has floating power supply E71, switching elements Q72H1 through Q72Hn and Q72L1 through Q72Ln, and switching element Q73. Switching elements Q72H1 through Q72Hn apply voltage on the high-voltage side of floating power supply E71 to scan electrodes SC1 through SCn, whereas switching elements Q72L1 through Q72Ln apply voltage on the low-voltage side of floating power supply E71 to scan electrodes SC1 through SCn. Switching element Q73 fixes voltage on the low-voltage side of floating power supply E71 to voltage Va.

Sustain electrode driving circuit 44 has sustain pulse generating circuit 80 and initializing/address voltage generating circuit 90. Sustain pulse generating circuit 80 has switching element Q85 for applying voltage Vs to sustain electrodes SU1 through SUn, switching element Q86 for applying 0 (V) to sustain electrodes SU1 through SUn, and power recovering section 89 for recovering power for the application of sustain pulses to sustain electrodes SU1 through SUn. Initializing/address voltage generating circuit 90 has switching element Q92 and diode D92 for applying voltage Ve1 to sustain electrodes SU1 through SUn, switching element Q94 and diode D94 for applying voltage Ve2 to sustain electrodes SU1 through SUn.

The switching elements above are formed of generally well-known devices, such as a metal oxide semiconductor field-effect transistor (MOSFET) and an insulated gate bipolar transistor (IGBT). The switching elements are controlled by each of timing signals generated in timing generating circuit 45.

The driving circuit of FIG. 10 is introduced as an example for generating the driving voltage waveforms shown in FIG. 7 and FIG. 8. The plasma display device of the present invention does not necessarily have the circuit structure.

Besides, specific values seen throughout the description of the embodiment are cited merely by way of example and without limitation. They should be optimally determined according to characteristics of a panel and specifications of a plasma display device.

### INDUSTRIAL APPLICABILITY

The plasma display device of the present invention offers stable address operation at high speed and excellent image having smooth gradation display without false contours. The plasma display device capable of showing high quality image is greatly useful for a display device.

1. A plasma display device comprising:
a plasma display panel including:
a front plate having display electrode pairs on a first glass substrate, a dielectric layer disposed so as to cover the display electrode pairs, and a protective layer disposed on the dielectric layer;
a back plate having data electrodes on a second glass substrate, the back plate being disposed opposite to the front plate; and
discharge cells formed at intersecting positions of the display electrode pairs and the data electrodes; and
a panel driving circuit for driving the plasma display panel in a manner that a plurality of subfields are temporally disposed to form one field period, each of the subfields having an address period for generating an address discharge and a sustain period for generating a sustain discharge in the discharge cells,
wherein the protective layer has
a base protective layer formed of a thin film of containing metal oxide; and
a particle layer formed in a manner that aggregated particles of plurality of single-crystal particles of magnesium oxide are stuck on the base protective layer, and
wherein the panel driving circuit drives the plasma display panel in a manner that an initializing discharge for forming wall charge is generated in a first subfield of the plurality of subfields, and an address discharge for erasing wall charge is generated in an address period of the plurality of subfields.

2. The plasma display device of claim 1,
wherein the panel driving circuit drives the plasma display panel in a manner that the display electrode pairs are divided into a plurality of display electrode pair groups, the address period is divided into a plurality of address sub-periods so as to correspond to the plurality of display electrode pair groups, and a replenish sub-period for supplying wall charge is disposed between an address sub-period and the subsequent address sub-period.
